(19) United States
(12) Patent Application Publication
(10) Pub. No.: US 2014/0048760 A1
(43) Pub. Date: Feb. 20, 2014

(54) SYNCHRONIZED LIFTING AND LOWERING APPARATUS

(71) Applicant: Frantz D. Stanford, Monona, WI (US)

(72) Inventor: Frantz D. Stanford, Monona, WI (US)

(21) Appl. No.: 14/058,753

(22) Filed: Oct. 21, 2013

Related U.S. Application Data
(60) Provisional application No. 61/757,485, filed on Jan. 28, 2013.

(30) Foreign Application Priority Data
Apr. 10, 2012 (US) PCT/US2012/032836

(51) Int. Cl. B66F 3/46; B66F 3/24; B66F 7/20

(52) U.S. Cl. CPC B66F 3/46; B66F 7/20; B66F 3/24
USPC 254/89 H

(57) ABSTRACT

A synchronous lifting or lowering system with hydraulic cylinders controlled by parallel-connected lift valves having two fluid passages. Hydraulic fluid for extending or retracting the actuators is delivered by a hydraulic supply system alternating between the two passages. Each time the supply circuit alternates passages, a fixed volume of hydraulic fluid is transferred during lifting or received during lowering by the respective lift or lowering valves to or from the cylinders causing the rods to lift or lower a proportionate amount. All of the rods extend during advancement or retract during lowering by approximately the same increment each time the supply circuit alternates passages. Because the rods all extend or retract the same increment each cycle, the load is lifted or lowered evenly and the need for height sensors or transducers is eliminated.

### CROSS-REFERENCE TO RELATED APPLICATION

This application claims the benefit of U.S. Provisional Patent Application No. 61/757,485 filed Jan. 28, 2013, and is a continuation-in-part of International Patent Application No. PCT/US2012/032836 filed Apr. 10, 2012, which claims the benefit of U.S. Provisional Patent Application No. 61/477,931, filed Apr. 21, 2011, the disclosures of which are hereby incorporated by reference for all purposes.

### STATEMENT CONCERNING FEDERALLY SPONSORED RESEARCH OR DEVELOPMENT

Not applicable.

### FIELD OF THE INVENTION

This invention relates to the lifting or lowering of large structures such as slabs, foundations, bridges, buildings and other structures using a number of hydraulic actuators in a synchronized manner. As used herein, “lifting” includes pushing, hoisting, and all other applications in which hydraulic actuators are extended or retracted synchronously.

### BACKGROUND OF THE INVENTION

Hydraulic systems for lifting structures such as slabs, foundations, bridges and buildings, ships, barges, oil platforms, or large transformers are known. The task is straightforward when the load of the structure is evenly distributed and when some flexing is allowed. Conversely, elevating (lifting or lowering) a structure that cannot be flexed or twisted or with uneven weight distribution, such as a slab poured on grade, is a somewhat more difficult operation. Without some control intervention, hydraulic flow to the lifting actuators takes the path of least resistance, resulting in the lightest portion of the load coming up first. This displacement differential may create internal stresses in the structure being elevated, increasing the likelihood of causing damage to the structure. In addition, the displacement differential can create instability during the lift, such that the lift set up could collapse. For lowering, something similar happens with the heaviest portion coming down faster than the lighter portions.

In order to lift or lower inflexible structures, or those with uneven weight distribution, without causing damage, a number of hydraulic systems, including manually, mechanically or electronically operated systems, have been designed with synchronous lift control capabilities to prevent twisting or uneven loading during an elevating operation (“elevating” as used herein includes lifting and lowering). However, these systems, depending on the type, are typically difficult to operate, complex to assemble, and/or very expensive. As a result, synchronized elevating of large structures is only used for high-level and complex lifting projects.

In response to the cost-prohibitive nature of existing hydraulic synchronized elevating systems, a low cost solution, i.e., a positive-displacement flow-divider, or PDFD was developed. The PDFD, however, is designed to elevate at a reduced operating pressure and limited to four segments or less, typically. Therefore, it is desirable to have other inexpensive yet more functional solutions that provide for synchronized elevating of large and uneven structures.

### SUMMARY OF THE INVENTION

The present invention alleviates these needs by providing a simple, cost effective synchronized elevating system that is almost unlimited in the number of lift-points that can be used. The invention provides a low-cost, minimally controlled solution for lifting or lowering uneven loads with little technical expertise needed by the operator.

The foregoing and other objects and advantages of the invention will appear in the detailed description which follows, In the description, reference is made to the accompanying drawings which illustrate a preferred embodiment of the invention.

### BRIEF DESCRIPTION OF THE DRAWINGS

FIG. 1 is a schematic view of a hydraulic circuit including a synchronous valve, an elevating cylinder, and a hydraulic supply system in accordance with one aspect of the present invention;

FIG. 2 is a graphical representation of a synchronized elevating system utilizing a plurality of the synchronous valves of FIG. 1;

FIG. 3 is a logic diagram for the hydraulic supply system of FIG. 1; and

FIG. 4 is a schematic view of a hydraulic circuit like FIG. 1 but for both synchronized lifting and synchronized lowering.

### DETAILED DESCRIPTION OF THE PREFERRED EMBODIMENT

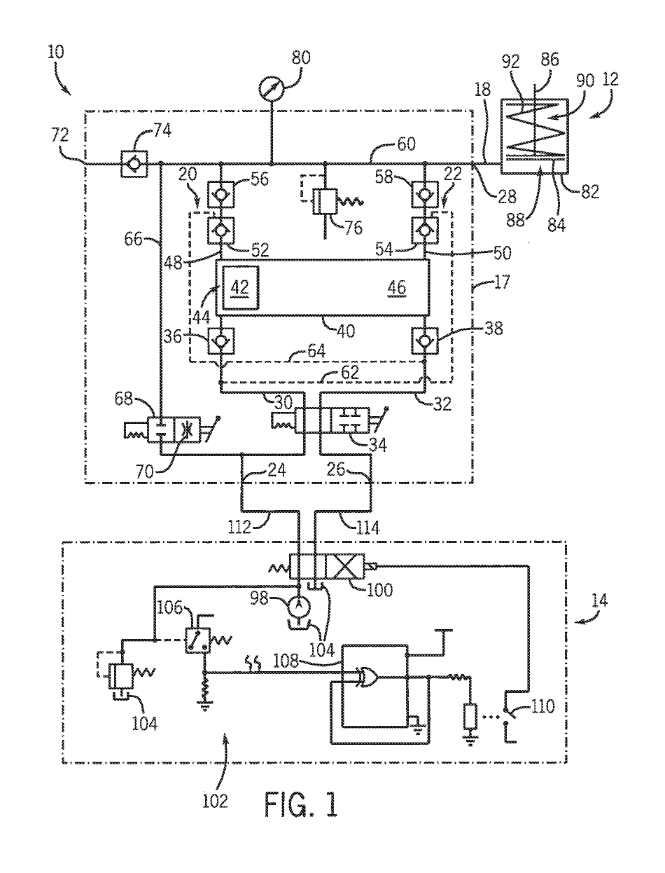

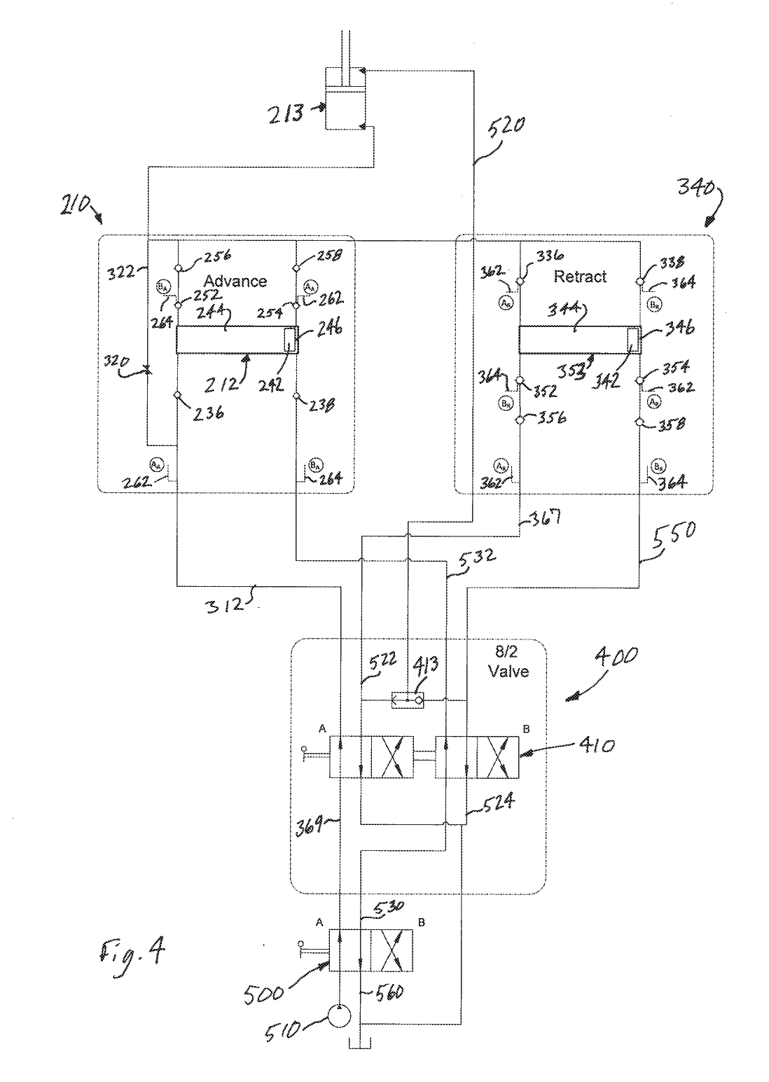

The present invention provides synchronized, incremental elevating (synchronized lifting and/or lowering) of a slab-like structure by a plurality of interconnected hydraulic actuators. The hydraulic and control circuits for a synchronous lift valve (sometimes referred to herein as an “elevating valve”, as “elevating” includes both lifting and lowering) and a synchronous lifting system are illustrated in the figures. As shown in FIG. 1, embodiments of a synchronous lift valve 10, single-acting lift cylinder 12, and fluid supply system 14 are schematically represented for a synchronized lifting system. FIG. 4 shows a system for synchronized lifting, like FIG. 1, but also for synchronized lowering.

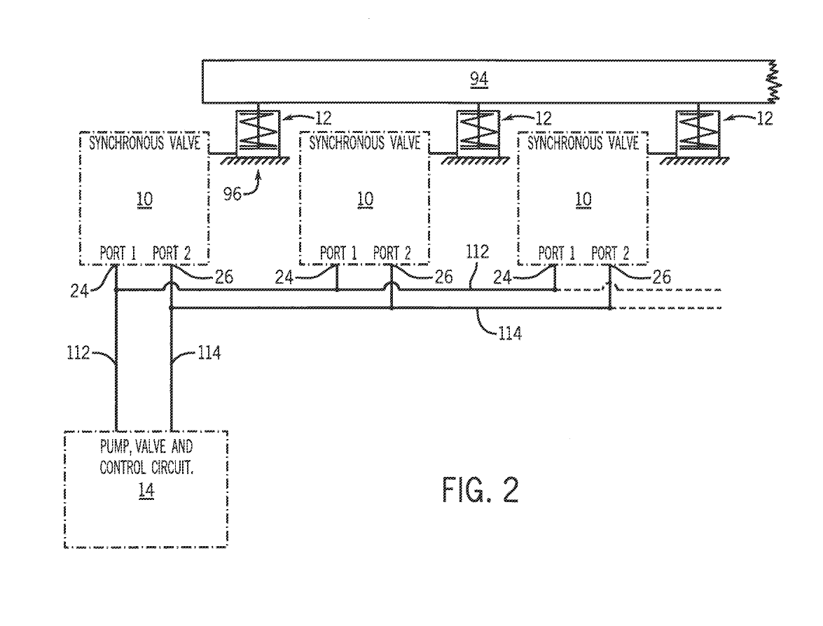

Referring to FIG. 1, the lift valve 10 incrementally delivers a fixed volume of pressurized incompressible fluid, such as hydraulic fluid, to the lift cylinder 12 as further discussed below. As shown in FIG. 2, one embodiment of a synchronized lift system 16 includes a plurality of interconnected lift valves 10, a plurality of lift cylinders 12 connected to a separate lift valve 10, and the fluid supply system 14 supplying pressurized fluid, i.e., an excitation input, to all of the lift valves 10. The terms “hydraulic” and “fluid” are used interchangeably, though the term “fluid” is not limited to just hydraulic fluid.

Referring initially to FIG. 1, the synchronous lift valve 10 is a compact assembly designed to be contained within a manifold 17 and installed in a supply line 18 between the lift cylinder 12 and the pressurized fluid supply 14. The synchronous lift valve 10 includes two distinct but interconnected fluid supply passages, first passage 20 and second passage 22.

The first and second passages 20, 22 begin at a pair of supply ports 24, 26 formed in the assembly 17, respectively, extend through a number of components contained therein, and end at a single outlet port 28. Each fluid passage 20, 22 includes an inlet line, 30, 32 that originates at the respective port 24, 26 and passes through a manually-operated block valve, i.e., on/off valve 34. Each inlet line 30, 32 further passes through a first check valve 36, 38, respectively, and into opposite ends of a fixed incremental volume device, or fluid metering cylinder 40.

The fluid metering cylinder 40 includes a sealed linear reciprocal piston 42 dividing the cylinder 40 into left, or first, and right, or second, variable-volume pressure chambers 44, 46, with no appreciable fluid flow past the piston 42. Each fluid passage 20, 22 further includes a respective outlet line 48, 50 that begins at the cylinder 40 and passes through a pilot-operated check valve 52, 54, respectively. Each outline line 48, 50 further passes through a second check valve 56, 58 and converges into a single supply line 60 that ends at the outlet port 28. The outlet port 28 is in fluid communication with a lower chamber 64 of the hydraulic lift cylinder 12 via the supply line 18.

The first check valves 36, 38, and second check valves 56, 58 operate as one-way passive barriers to selectively open and close the passages 20, 22 depending on the direction of fluid flow therein. The pilot-operated check valves 52, 54 operate as conventional check valves to prevent the flow of fluid from the metering cylinder 40 into the outlet lines 48, 50. However, these valves 52, 54 perform a different function when acted on by a pilot, i.e., a separate fluid pressure source. Specifically, when the inlet line 30 of the first passage 20 is pressurized, fluid is directed through a line 62 to open the valve 54 and permit two-way fluid flow therethrough. Similarly, by separate operation of the inlet line 32 of the second passage 22, fluid is directed through a line 64 to open valve 52 and permit two-way flow therethrough. When there is no fluid pressure within inlet line 30, the pilot function is removed and valve 54 closes to provide a passive barrier in the second passage 22. Similarly, when there is no fluid pressure within inlet line 32, the pilot function is removed and valve 52 closes to provide a passive pressure barrier in the first passage 20.

The metering cylinder 40 is operated to provide a fixed, or metered, amount of fluid to the lift cylinder 12 resulting in a proportionate amount of lift in a manner explained below. Further components of the synchronous lift valve 10 include a fluid return passage 66 having a block valve 68 with flow restrictor 70, an auxiliary inlet port 72 that can be used to add more hydraulic fluid to the lift cylinder 12, an auxiliary inlet port check valve 74, a pressure relief valve 76, and a pressure gauge 80.

The lift cylinder 12 includes a cylinder barrel 82 and a displaceable piston 84 contained therein. The piston 84 is connected to a piston rod 86 extending upwardly and outwardly from the barrel 82. A lower (bore side) chamber 88 and an upper (rod side) chamber 90 are formed within the barrel 82 on opposite sides of the piston 84. As is well known, hydraulic fluid delivered to the lower chamber 88 causes an upward force to be applied against the piston 84. A spring 92 situated within the upper chamber 90 biases the piston 84 in a downward direction. Referring also to FIG. 2, the rod 86 lifts a slab 94 or a support plate such that when the upward force is greater than the downward forces (including the weight of the slab 94), the piston 84 translates upward within the barrel 82 and the piston rod 86 raises the slab 94. A reaction point 96 (see FIG. 2) is provided by a mechanical pier, piling, or other stable foundation in the ground. FIG. 2 is a schematic illustration; typically the pier 96 is below the slab 94, the cylinder 12 is supported above the slab 94 by a lift structure (not shown) that is supported on the pier 96, and the lift structure couples the piston 84 and the slab 94 so the movement of the piston 84 is translated to the slab 94.

As foundation, slab and bridge lifting applications usually are high tonnage lifts, it is desirable and usual in such applications that the lift cylinder 12 used for such lifts is a high pressure actuator capable of pressures as high as 10,000 psi. The rod 86 is sized accordingly to bear the load for particular applications.

The synchronous lift valve 10 is supplied with pressurized hydraulic fluid by the hydraulic supply system 14 that includes a pump 98, a four-way/two-position solenoid, or fluid supply solenoid valve 100, and a pressure control circuit 102. The pump 98 in the embodiment shown is capable of delivering hydraulic fluid at pressures up to 10,000 PSI. As shown in FIG. 1, when the fluid supply solenoid valve 100 is in the illustrated first, de-energized position, pressurized hydraulic fluid is directed to the first port 24 of the lift valve 10 while the second port 26 is in fluid communication with a fluid reservoir 104. A pressure actuated switch 106 is connected to the output of the pump 98. When the fluid pressure reaches a certain threshold, i.e., a maximum set pressure, for example, 8,000 PSI, switch 106 closes, energizing a two-position latching relay 108 which in turn closes a set of normally open contacts 110. Consequently, the supply solenoid valve 100 becomes energized and alternates to a second, energized position.

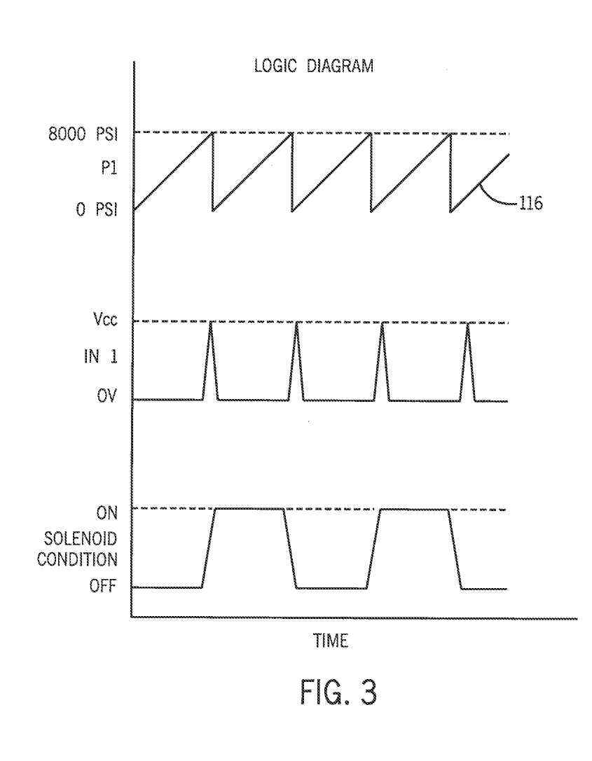

When the solenoid valve 100 is energized, pressurized hydraulic fluid is directed to the second port 26 of the lift valve 10 and the first port 24 is in fluid communication with the reservoir 104. Pressure switch 106 opens again when the valve 100 shifts, since the pressure drops below the set limit. The supply solenoid valve 100 remains energized by action of the relay 108 which remains latched until the pressure switch 106 is closed again. As shown in FIG. 3, during normal operation, the solenoid valve 100 alternates between the energized and de-energized state in a cycle having constant and equal intervals. In other words, the hydraulic supply system 14 alternately delivers pressurized hydraulic fluid to the first and second ports 24, 26, switching between the two ports 24, 26 each time the pressure switch 106 is momentarily closed. As an alternative to the supply system 14, a pump with a programmable control could be used, or the system could be manually operated so as to lift in a series of increments.

Specifically referring to FIG. 2, one embodiment of a synchronized lifting system 16 of the present invention includes a plurality of synchronous valves 10 and corresponding lift cylinders 12 spaced apart to lift the slab 94 in a known manner. Each lift cylinder 12 is connected to and controlled by a separate lift valve 10. The hydraulic supply system 14 delivers pressurized hydraulic fluid to each of the valves 10 via a set of supply lines 112, 114. As shown, the lift valves 10 are plumbed together in parallel via the supply lines 112, 114. Each of the first ports 24 of the system 16 are in fluid communication with each other while each of the second ports 26 are likewise in fluid communication with each other. The outlet port 28 of each synchronous valve 10 is only in fluid communication with the associated lift cylinder 12 via separate supply lines 18.

In operation, the on/off valve 34 of the lift valve 10 is manually opened and the return valve 68 is manually closed. The supply solenoid valve 100 is initially in the de-energized position. The pump 98 is turned on and pressurized hydraulic fluid is delivered via supply line 112 to the first port 24 of the lift valve 10, as well as to all the other first ports 24 connected in parallel to the supply line 112. A typical hydraulic fluid pressure curve 116 is shown in FIG. 3. The hydraulic fluid flows into the first passage 20 through the first port 24, on/off valve 34, first check valve 36, and into the left chamber 44 of the metering cylinder 40.

As the pressurized fluid enters the left chamber 44, the piston 42 is forced to move through its stroke and displaces the entire volume of hydraulic fluid, i.e., a fixed volume shot, from the right chamber 46 into the outlet line 50 of the second passage 22. The pilot-operated valve 54 is open due to the presence of pressurized fluid in the inlet line 30 of the first passage 20. Thus the displaced fluid from the right chamber 46 flows through the valve 54, through the second check valve 58 and into the lower chamber 88 of the lift cylinder 12. Each metered volume of fluid delivered to the cylinder 12 results in a proportionate amount, or increment, of vertical movement, or lifting, of the piston 84, rod 86 and slab 94 because of the incompressible nature of the fluid. Each parallel-connected lift valve 10 in the synchronous lift system 16 acts in an identical manner and causes each associated lift cylinder 12 to raise the slab 94 up by the same incremental amount.

When the hydraulic fluid reaches the pressure set point, pressure switch 106 momentarily closes, activating the relay 108 which in turn energizes the supply solenoid valve 100. The pressure limit set point is significantly higher than the highest pressure required by any of the cylinders 12 to lift its load, so all of the cylinders 12 have extended by the volume and fluid displaced into them from the right chamber 46 and have stopped extending before the pressure limit set point is reached. Therefore, they have all extended the same amount, although not necessarily at the same rate. For as long as the solenoid valve 100 is energized, hydraulic fluid is directed from the pump 98 to the second port 26. As shown in FIG. 3, the pressure of the supplied hydraulic fluid initially drops when the solenoid valve 100 is energized but immediately begins to recover. As discussed above, regardless of the subsequent drop in pressure in the fluid supply system 14, which opens switch 106, the solenoid valve 100 remains energized by operation of the latching relay 108.

Hydraulic fluid is thus directed into the second passage 22 through the second port 26, on/off valve 34, first check valve 38, and into the right chamber 46 of the metering cylinder 40. The fluid accumulating in the right chamber 46 causes the piston 42 to travel through a reverse stroke toward the left as viewed in FIG. 1, having been moved to the right on the previous stroke, expelling the volume of fluid from the left chamber 44 into the outlet line 48 of the first passage 20. The fluid is forced through the pilot-operated check valve 52 (which is open because of the presence of pressurized fluid in line 32), second check valve 56, and into the lower chamber 88 of the lift cylinder 12. This additional volume of fluid causes the piston 84, rod 86, and slab 94 to be raised by another increment and then stop when the associated piston 42 stops. The fluid pressure continues to build until it reaches the set pressure when the switch 106 closes. The relay 108 unlatches and contacts 110 open, thereby de-energizing the solenoid valve 100. The solenoid valve 100 returns to the de-energized position and hydraulic fluid is once again directed to the first passage 20. Due to the pressure drop, pressure switch 106 subsequently opens. The cycle of delivering a metered amount of hydraulic fluid to the cylinder 12 in this manner is repeated over and over until the slab 94 has been lifted to a desired height or the rods 86 have been extended to their full extension.

To lower the rods 86 after being decoupled from the slab 94, on/off valve 34 is closed, the lift/lower block valve 68 is opened, and the solenoid valve 100 is energized. Hydraulic fluid is pushed out of the cylinder barrels 82 by the downward forces including the spring 92 decompressing force against the piston 84. The fluid is directed through the outlet port 28 and into the return line 60. The fluid is prevented from flowing into the metering cylinder 40 by the second set of check valves 56, 58. The fluid passes through the flow restrictor 70, through the energized solenoid valve 100, and into the reservoir 104. The flow restrictor 70 restricts flow to provide a more slow controlled descent or retraction of the cylinders 12.

By plumbing each synchronous valve 10 of the synchronous lift system 16 in parallel, the pressure of the hydraulic fluid delivered to each lift cylinder 12 is, for all practical purposes, the same. In other words, all cylinders 12 will be pressurized at the same rate, regardless of load. However, not all of the rods 86 will necessarily be lifted at the same time. Depending on the weight of the portion of the slab 94 supported by the rod 86, some lift cylinders 12 will require a greater fluid pressure to effect a lift. The cylinders 12 requiring a lower pressure to be extended will be extended first or at a higher rate, with the cylinders 12 requiring a higher pressure following. However, regardless of the rate of lifting during each extension, each rod 86 is only extended one increment per cycle and all of them are extended one increment. The increment is determined by the volume displaced from the metering cylinder 40 on each stroke. As such, the difference in height between any two rods 86 is never more than a single increment and never for longer than the time it takes for the pump 98 to reach a pressure sufficient to cause any slow or heavily loaded rods 86 to be extended. Then after they have all extended and all of the pistons 42 have stopped, the set pressure limit (e.g., 8,000 psi) is quickly reached and a new stroke cycle is started. Thereby, the rods of all of the cylinders are extended in a series of successive increments until the desired lift elevation is reached, at which time the valve 34 is turned off to hold the load at that elevation while it is secured with bolts or other means to support it at that elevation, so the lifting cylinders, valves and other lifting system components can be removed and reused.

In one example, the synchronized lifting system 16 is used on a slab 94 with an uneven weight distribution. The metering cylinder 40 and barrel 82 are sized such that each metered volume of hydraulic fluid displaced from the metering cylinder 40 causes the piston 84 and rod 86 to be lifted by 0.125″. A lift cylinder 12 under a lighter portion of the slab 94 may need 1,000 PSI of hydraulic pressure to lift the associated rod 86, while another lift cylinder 12 under a heavier portion may need 2,000 PSI to lift the associated rod 86. When the pump 98 is turned on, the pressure of the hydraulic fluid eventually reaches 1,000 PSI, at which point the rod 86 under the lighter portion is lifted. The pressure continues to increase until reaching 2,000 PSI, at which point the rod 86 under the heavier portion is lifted. As previously described, for each cycle, the hydraulic fluid pressure builds until reaching the pressure set-point at which point all of the rods 86 will have been raised by an increment of 0.125″. If, during or at the end of lifting not all of the cylinders are at the same height due to some small error, or to make desired adjustments, a secondary pump may be hooked up to the auxiliary inlet port 72 to make up the difference. Another way to do this, if one point is too high, is to turn off the valve 34 at that point and raise the other lift points.

The invention thereby provides a synchronized hydraulic lifting system with minimal electronic controls to understand, fail or learn, no height sensors needed, that can he used with all identical actuators, and in which the attachment points, i.e., the ports 24 and 26, can be polarized (i.e., mechanical connectors used so that each first port 24 can only be connected to another first port 24 and vice versa) to facilitate assembly. Further, this system can be used in the lifting of slab foundations, houses and similar structures that are made of materials that do not allow them to be twisted or flexed significantly without causing damage.

Additional embodiments have been contemplated regarding the slightly compressible nature of hydraulic fluid, or that hydraulic fluid may become aerated and become further compressible. If the fluid is slightly compressible and there are different loads on each lift point, lift point to lift point height differences, i.e., error, may occur during a lifting operation. Therefore, one contemplated embodiment of a synchronous lift system 16 uses a fluid with a very low compressibility (i.e., high bulk modulus) and isolates that fluid from the pump 98 by attaching a cylinder (not shown) with a floating piston to each port 24, 26 of each lift valve 10. The fluid with very low compressibility (e.g., glycol or similar) would be contained within the valve 10 by the floating piston while the supply system other side of the floating piston would have standard hydraulic oil, With such an arrangement, aeration would be eliminated and the compressibility of the fluid in the lift valve 10 could be reduced by a factor of two or three.

FIG. 4 illustrates a system like FIG. 1 but in which elevating valves 210 and 340 are provided to either lift using lift valve 210 or lower using lowering valve 340 a load synchronously as applied to multiple cylinders distributed about the load at multiple lift points. The lift valve 210 operates very similarly to the lift valve 10 of FIG. 1 having a shuttle chamber 212 like the shuttle chamber of FIG. 1 that comprises the variable volume chambers 44 and 46 and the piston 42. Elements 236, 238, 242, 244, 246, 253, 252, 254, 256, and 258 correspond to the same numbered elements in FIG. 1 minus 200. For advancing, the function of these elements is the same with check valve 252 being opened by the pressure in line 264, the symbol B_{A} indicating that the two lines 264 are connected. Pilot operated check valve 254 is opened by the pressure in line 262, with the symbol A_{A} indicating that the two lines 262 shown in FIG. 4 are connected.

Element 320 in the lift valve 210 is a bypass valve that would normally close off the line 322 but can be opened so as to bypass the shuttle cylinder 212 and associated check valves 236, 252, 256 so as to provide a direct connection between line 312 and the bore side of the double-acting cylinder 213.

On the right side of FIG. 4, a lowering valve 340 is provided. The lowering valve 340 has a shuttle cylinder 352 with variable volume chambers 344 and 346 separated by a piston 342 just like the lift valve 210. However, since in the lowering valve 340 the shuttle cylinder 353 is metering the fluid coming out of the bore side of the cylinder 213, the single pilot operated check valves 336 and 338 are between the bore side of the cylinder 213 and the respective variable volume chambers of the shuttle cylinder 353 and the double check valves 352, 356 on the left, and 354, 358 on the right, are between the shuttle cylinder 353 and the control valves 400, 500 and pump and tank. The valves 352 and 354 are pilot operated, just like the valves 252 and 254 on the advance side are pilot operated. The valves 352 and 354 on the retract side are operated by the respective pressures B_{R} and A_{R}. These are analogous to the respective pressures B_{A} and A_{A} on the advance side. The pressure B_{R} is associated with line 364 and the pressure A_{R} is associated with line 362.

The check valves 336 and 338 are also pilot operated and opened by the respective pressures A_{R} and B_{R} so they are only opened when a pressure exists in the respective lines 362 and 364.

The lift and lower valves 210 and 340 are controlled by a series of two valves 400, 500. Valve section 400 is an eight-way, two-position, or 8/2 valve 410 and a shuttle check valve 413. The valve 410 is provided by mechanically connecting two four-way, two-position valves. For example, the spools of each of the 4/2 valves may be mechanically connected so that they shift together. This is indicated by the two horizontal lines between the two 4/2 valves that make up the valve 410. When line 522 is pressurized, the ball in shuttle valve 413 moves to the right to seal the seat at that end and when line 550 is pressurized the ball and shuttle 413 moves to seal the seat at the left.

Valve 500 is similar in function to the valve 100 of FIG. 1. The valve 500 may be manually operated or operated by a switching circuit like that shown in FIG. 1, so valve 500 is for being repetitively cycled to either advance the cylinder 213 or if valve 400 is shifted to the retract mode, to retract the cylinder. If the retract mode is operated by a switching circuit, it would be triggered somewhat differently. When a retract cycle ends can he sensed by when the flow returning to the tank stops, for example by a pressure transducer in front of a flow restricting orifice on the line going back to tank. So the circuit would switch to cycle the valve 500 each time the sensed pressure went below a set limit. Valve section 400 is for the purpose of selecting whether to extend or retract the cylinder 213, the valve 400 being shown in the extend position. When the valve 410 is shifted to the left, which may be done manually or electronically, the valve 410 shifts to the retract position.

The extend position works as described above. Pump 510 pumps through valves 500 and 410 to line 312. The left side of shuttle cylinder 212 fills and presses fluid out of its right side 246 past check valve 254 which is opened by the pressure from the pump in line 262. The fluid flows past check valve 258 into the bore side of the cylinder 213. Fluid on the rod side flows through line 520 through shuttle 413 to line 522, or to line 550 if the ball in shuttle valve 413 is on the left, and through valve 410 to line 524 which is connected to tank. This delivers a shot or fixed volume of fluid to advance the cylinder 213 a known and fixed quantity.

After piston 242 moves all the way to the right to continue advancing the cylinder 213 it must be moved to the left to continue advancing the cylinder 213. This is accomplished by shifting the valve 500 leftwardly which sends fluid from the pump 510 through line 530 and through valve 410 to line 532. The fluid in line 532 pressurizes line 264 and flows through check valve 238 to compress chamber 246 and move shuttle piston 242 leftwardly. The pressure in line 264 opens check valve 252 so fluid in chamber 244 can flow past check valve 252 and 256 and into the bore side of the cylinder 213.

This process of advancing the cylinder continues as long as the valve 410 is left in the extend position and the valve 500 is shuttled back and forth. Each time, the cylinder 213 receives a shot of hydraulic fluid of a known and fixed quantity equal to the displacement of either the variable volume chamber 244 or the variable volume chamber 246, which are equal. Thus, the number of times that the valve 500 is shuttled determines how far the cylinder 213 is extended.

When retraction of the cylinder 213 is desired, lowering valve 340 is employed and it works in the reverse manner from the advance of the cylinder. Fluid flows from the bore side of the cylinder 213 to the shuttle cylinder 353 and from there is pumped by the shuttle cylinder 353 to tank in shots. To retract, the valve 410 is moved to its leftward position. During the retract mode, pump 510 is operated to pump fluid through the valves 500, 410 and 413 to the line 520, which forces fluid into the rod side of the double acting cylinder 213 to force the piston of the cylinder 213 to retract and pressurize the bore side of the cylinder 213. This is not necessary if the cylinder is a spring-retract, single-acting cylinder like in FIG. 1, in which case the line 520 could be capped, for example at valve 400, and the rod side of the cylinder 213 would not be connected to hydraulic, pressure. However, if it is a double-acting cylinder, the cylinder 213 can be positively displaced in the retract mode by the circuit of FIG. 4. When the pump is operated in the retract mode, it also pressurizes line 522 which pressurizes line 362. Pressurizing line 362 opens cheek valve 336 which admits fluid to cylinder 353 to force the piston 342 of shuttle cylinder 353 to the right, thereby pressing fluid out of chamber 346. The pressure in line 362 also opens check valve 354 so that the fluid pressed out of chamber 346 can flow through check valve 354 and check valve 358 and to tank via lines 550, 530, and 560. After the piston 342 is moved all the way to the right, the valve 500 is shuttled to its leftward position which with the valve 410 in the leftward retract position pressurizes line 550, Which pressurizes line 364, which opens check valves 352 and 338, thereby permitting fluid to flow from the bore side of the cylinder 213 into chamber 346 and move piston 342 to the left. Fluid from chamber 344 is pressed out of the cylinder 353 past check valve 352 and check valve 356 into line 367 to line 369 through valve 410 and to line 560 through valve 500, from which it goes to tank.

Thereby, a hydraulic circuit that can be used with either a single-acting or a double-acting lift cylinder and is selectable between a metered advance and a metered retract is provided. A number of cylinders may be synchronously operated both to lift and to lower by using the same section 400 to operate all of the cylinders, with each cylinder being provided with separate elevating valves 210 and 340, valve 210 for lifting and valves 340 for lowering.

Preferred embodiments of the invention have been described in considerable detail. Many modifications and variations to the preferred embodiments described will be apparent to a person of ordinary skill in the art. Therefore, the invention should not be limited to the embodiments described.

I claim:

1. A synchronous elevating system having a plurality of lift cylinders distributed about a load at lifting points to elevate each lifting point of the load by approximately the same increment as the increments of the other lifting points, the system comprising:
a plurality of elevating valves, each elevating valve having a first port in fluid communication with a first variable volume chamber and a second port in fluid communication with a second variable volume chamber;
a plurality of lift cylinders, each of said lift cylinders being in fluid communication with an associated one of said elevating valves;
wherein each of said first and second variable volume chambers of said elevating valves are in fluid communication with a load port of said associated lift cylinder such that extension of the rods of the plurality of lift cylinders changes by the same increment When a fluidic pressure is applied to the plurality of elevating valves.

2. A synchronous lifting system as in claim 1, wherein each of the elevating valves includes an outlet port.

3. A synchronous lifting system as in claim 2, wherein each of the elevating valves are for advancing the associated cylinder and includes a first pilot-operated check valve between the first variable volume chamber and the outlet port that prevents fluid in said first variable volume chamber from flowing to said lift cylinder when there is no pressure between the second port and the second variable volume chamber.

4. A synchronous lifting system as in claim 3, wherein each of the elevating valves are for advancing the associated cylinder and includes a second pilot-operated check valve between the second variable volume chamber and the outlet port that prevents fluid in said second variable volume chamber from flowing to said lift cylinder when there is no pressure between the first port and the first variable volume chamber.

5. A synchronous lifting system as in claim 1, further comprising controls that repetitively alternate a valve so as to change the extension of the rods of the plurality of lift cylinders in a series of successive increments.

6. A synchronous lifting system as in claim 2, wherein each of the elevating valves are for retracting the associated cylinder and includes a first pilot-operated. check valve between the first variable volume chamber and a port that prevents fluid in said first variable volume chamber from flowing out of said first variable volume chamber when there is no pressure between the second port and the second variable volume chamber.

7. A synchronous lifting system as in claim 3, wherein each of the elevating valves are for retracting the associated cylinder and includes a second pilot-operated check valve between the second variable volume chamber and a port that prevents fluid in said second variable volume chamber from flowing out of said second variable volume chamber when there is no pressure between the first port and the first variable volume chamber.

8. A method of lifting a load including the steps of:
distributing a plurality of hydraulic lift actuators at lifting points positioned about the load;
connecting each of the plurality of actuators to an associated one of a plurality of lift valves, each lift valve having a first, a second and a third port and providing a metered output from said third port when a fluid supply is connected to said first and second ports;
connecting the plurality of lift valves to one another in parallel such that all of said first ports are in fluid communication with each other and all of said second ports are in fluid communication with each other;
introducing pressurized fluid to the parallel-connected first supply ports so as to cause the rods of the actuators to extend by approximately the same increment;
introducing pressurized fluid to the parallel-connected second supply ports so as to cause the rods of the actuators to extend by approximately the same increment; and
alternating the introduction of said pressurized fluid between the first and second parallel-connected supply ports.

9. A method of lowering a load including the steps of:
distributing a plurality of hydraulic actuators at lifting points positioned about the load;
connecting each of the plurality of actuators to an associated one of a plurality of lowering valves, each lowering valve having a first, a second and a third port and accepting a metered input from said third port when a fluid supply is connected to one or the other of said first and second ports;
connecting the plurality of lowering valves to one another in parallel such that all of said first ports are in fluid communication with each other and all of said second ports are in fluid communication with each other;
introducing pressurized fluid to the parallel-connected first supply ports so as to cause the rods of the actuators to retract by approximately the same increment;
introducing pressurized fluid to the parallel-connected second supply ports so as to cause the rods of the actuators to retract by approximately the same increment; and
alternating the introduction of said pressurized fluid between the first and second parallel-connected supply ports.

10. A synchronous lift system or extending a plurality of hydraulic actuators in unison, comprising:
a plurality of hydraulic actuators, each said actuator having a cylinder barrel and a piston in the cylinder barrel that defines at least one sealed variable volume chamber in the cylinder barrel;
a plurality of valves, one said valve associated with each said hydraulic actuator, each said valve comprising a fixed incremental volume device that in response to an excitation input to the valve, outputs to the actuator a fixed volume shot of hydraulic fluid to extend the actuator a certain amount in accordance with the volume of the shot, wherein the valves are connected to receive the excitation input at the same time after each valve has output the shot of fluid to its associated actuator; and
a pressure supply connected to the valves to provide a series of excitation inputs to the valves so as to incrementally and repetitively extend the actuators.

11. A synchronous lift system as in claim 10, wherein the fixed incremental volume device includes a first variable volume chamber and a second variable volume chamber that varies in volume inversely proportional to the volume of the first variable volume chamber such that introducing fluid from the pressure supply to the first variable volume chamber presses the fixed volume shot of hydraulic fluid out of the second variable volume chamber to the actuator and introducing fluid from the pressure supply to the second variable volume chamber presses the fixed volume shot of hydraulic fluid out of the first variable volume chamber to the actuator.

12. A synchronous lift system as in claim 11, wherein the series of fixed volume shots of hydraulic fluid are delivered to the actuator by alternately introducing fluid to the first variable volume chamber and second variable volume chamber.

13. A synchronous lift system as in claim 12, wherein each shot of fluid flows from a variable volume chamber through a pilot pressure operated valve.

14. A synchronous lift system as in claim 13, wherein each valve has a first supply port and a second supply port, each of which are connected to the pressure supply and which are alternately pressurized and vented to tank pressure so as to provide the series of excitation inputs to the valve.

15. A synchronous lift system as in claim 14, wherein the pressure supply includes a latching relay that holds supply pressure on one of the supply ports and tank pressure on the other of the supply ports until a supply pressure limit is reached, and then holds tank pressure on the one of the supply ports and supply pressure on the other of the supply ports until the supply pressure limit is reached again, at which time it switches back and the cycle continues.

16. A synchronous lift system as in claim 15, wherein the pressure supply further includes a pressure operated switch that triggers the latching relay when the supply pressure limit is reached.

17. A synchronous lift system as in claim 10, wherein each of the plurality of valves further comprises an auxiliary port through which fluid under pressure can be introduced into the associated actuator.

18. A synchronous level elevating system for extending and retracting a plurality of hydraulic actuators in unison, comprising:
a plurality of hydraulic actuators, each said actuator having a cylinder barrel and a piston in the cylinder barrel that defines at least one sealed variable volume chamber in the cylinder barrel;
a plurality of sets of elevating valves, each set including at least one lift valve and at least one lowering valve and being associated with each said hydraulic actuator, each said lift valve comprising a fixed incremental volume device that in response to an excitation input to the valve, outputs to the actuator a fixed volume shot of hydraulic fluid to extend the actuator a certain amount in accordance with the volume of the shot, wherein the advance valves are connected to receive the excitation input at the same time after each advance valve has output a shot of fluid to its associated actuator, and each said lowering valve comprising a fixed incremental volume device that in response to an excitation input to the valve accepts from the actuator a fixed. volume shot of hydraulic fluid to retract the actuator a certain amount in accordance with the volume of the shot, wherein the lowering valves are connected to receive the excitation input at the same time after each lowering valve has received a shot of fluid from its associated actuator; and
a pressure supply connected to the valves to provide a series of excitation inputs to the valves so as to incrementally and repetitively extend or retract the actuators synchronously.

19. A synchronous lift system as in claim 18, wherein each shot of fluid from the elevating valves flows from a variable volume chamber through a pilot pressure operated valve.

20. A synchronous lift system as in claim 18, wherein each elevating valve has a first supply port and a second supply port, each of which are alternately pressurized and vented to tank pressure so as to provide the series of excitation inputs to the valve.

21. A synchronous lift system as in claim 18, further comprising an eight way two position valve to select between an advance mode and a retract mode of operation of the system.
